(19) United States
(12) Patent Application Publication
(10) Pub. No.: US 2022/0067128 A1
(43) Pub. Date: Mar. 3, 2022

(54) TERMINAL DEVICE SECURITY MANAGEMENT DEVICE, METHOD, AND TERMINAL DEVICE

(71) Applicant: ZHENGZHOU FULIAN INTELLIGENT WORKSHOP CO., LTD., Zhengzhou (CN)

(72) Inventors: JIN-XING LI, Zhengzhou (CN); ZI-REN GUO, Zhengzhou (CN); FU-NUNG TSO, New Taipei (TW)

(21) Appl. No.: 17/466,041

(22) Filed: Sep. 3, 2021

(30) Foreign Application Priority Data
Sep. 3, 2020 (CN) 202010916982.4
Sep. 3, 2020 (CN) 202010917005.6

(51) Int. Cl. G06F 21/10; H04L 29/06

(52) U.S. Cl. CPC G06F 21/105; G06F 2221/0791; H04L 63/0876

(57) ABSTRACT

A terminal device security management device and method are involved a terminal device management field. By grading network level, a level of functions being forbidden to be invoked, formed by obtaining a network connected by the terminal device, is sent to the terminal device for managing invoking operations of the functions. The terminal devices in different management domains are managed based on different connected networks for licensing the terminal device to invoke different function sets in different management domains. Work efficiency is improved, and a risk of leaks is reduced. A terminal device and a method of the terminal device are also disclosed. By responding information of a management device, a licensed function set is displayed in a display, or an invoking of the function is forbidden based on an invoking request for avoiding the specified function to be invoked in the management domain. The leak risk is further reduced.

### FIELD

The subject matter herein generally relates to terminal device security management field, specifically relates to a terminal device security management device, a terminal device security management method, and a terminal device.

### BACKGROUND

A management domain being strictly confidential is formed in manufacture industries, such as closed factories, terminal devices are usually being controlled. Functions being controlled includes cameras, BLUETOOTH, and WI-FI. Once the terminal device can connect to a network or is taken out of the management domain, important information may be leaked, and security risks increased. Thus, factories can provide industrial terminals to staff in the management domain, and divide the factory into different management domains corresponding to different management requirements. How to effectively manage the industrial terminals in different domains for licensing the industrial terminals to invoke different function sets in different management domains becomes more important for both work efficiency and reduction of risk of leaks.

There is room for improvement in the art.

### BRIEF DESCRIPTION OF THE FIGURES

Implementations of the present disclosure will now be described, by way of example only, with reference to the attached figures.

FIG. 1 is a diagram illustrating an environment of a management system in one embodiment.

FIG. 2 is a diagram illustrating an embodiment of a physical process and a digital replica of the management system according to the present disclosure.

FIG. 3 is a diagram illustrating an embodiment of a terminal device security management device in the system according to the present disclosure.

FIG. 4 is a diagram illustrating an embodiment of the licensing module of the terminal device security management device of FIG. 3 according to the present disclosure.

FIG. 5 is a diagram illustrating an embodiment of a terminal device in the system according to the present disclosure.

FIG. 6 is a diagram illustrating an embodiment of a responding module of the terminal device of FIG. 5 according to the present disclosure.

FIGS. 7A-7F are flowcharts illustrating methods applicable in a terminal device security management system in different embodiments of the present disclosure.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure.

The term “coupled” is defined as connected, whether directly or indirectly through intervening components, and is not necessarily limited to physical connections. The connection can be such that the objects are permanently connected or releasably connected.

Unless otherwise expressly stated, all technical and scientific terminology of the present disclosure are the same as understood by persons skilled in the art. The terminology used in the description of the various described embodiments herein is for the purpose of describing particular embodiments only and is not intended to be limiting. The term “comprising” means “including, but not necessarily limited to”; it specifically indicates open-ended inclusion or membership in a so-described combination, group, series, and the like.

Various embodiments of the disclosure may take the form of an entirely or partially hardware embodiment, an entirely or partially software embodiment, or a combination of software and hardware (e.g., a firmware embodiment). Further, as described herein, various embodiments of the disclosure (e.g., systems and methods) may take the form of a computer program product including a computer-readable non-transitory storage medium having computer-accessible instructions (e.g., computer-readable and/or computer-executable instructions) such as computer software, encoded or otherwise embodied in such storage medium.

Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can be embodied in or can include ROM; RAM; magnetic disk storage media; optical storage media; flash memory, etc.

At least some of the embodiments of the operational environments and techniques are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or technique put forth herein be construed as requiring that its acts or steps be performed in a specific order. Accordingly, where a process or a method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of embodiments described in the specification or annexed drawings, or the like.

As used in this application, the terms “environment,” “system,” “engine,” “module,” “component,” “architecture,” “interface,” “unit,” and the like refer to a computer-related entity or an entity related to an operational apparatus with one or more defined functionalities. The terms “environment,” “system,” “engine,” “module,” “component,” “architecture,” “interface,” and “unit” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. In still another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

As is utilized in this disclosure, the term “communicator” can refer to any type of communicating circuitry or device. A communicator can be embodied in or can include several types of network components, including base stations; router devices; switch devices; server devices; aggregator devices; bus architectures; a combination of the foregoing; or the like. One or more of the bus architectures can include an industrial bus architecture, such as an Ethernet-based industrial bus, a controller area network (CAN) bus, a Modbus, other types of fieldbus architectures, or the like.

As is utilized in this disclosure, the term “processor” can refer to any type of processing circuitry or device. A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory. Additionally, or as another example, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed or otherwise configured (e.g., manufactured) to perform the functions described herein. In some embodiments, processors can utilize nanoscale architectures. in order to optimize space usage or enhance the performance of systems, devices, or other electronic equipment in accordance with this disclosure. For instance, a processor can include molecular transistors and/or quantum-dot based transistors, switches, and gates.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects. Memory components or memory devices disclosed herein can be embodied in either volatile memory or non-volatile memory or can include both volatile and non-volatile memory. In addition, the memory components or memory devices can be removable or non-removable, and/or internal or external to a computing device or component. Examples of various types of non-transitory storage media can include hard-disc drives, zip drives, CD-ROMs, digital versatile disks (DVDs) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device. As an illustration, non-volatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory devices or memories of the operational or computational environments described herein are intended to include one or more of these and/or any other suitable types of memory.

Conditional language, such as, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable non-transitory storage medium within the respective computing/processing device.

What has been described herein in the present specification and annexed drawings includes examples of systems, devices, techniques, and computer program products that, individually and in combination, permit the tracking and traceability of parts of a product manufactured in industrial equipment. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

Management domain being strictly confidential is formed in a manufacture industry, such as a closed factory, terminal devices are usually being controlled. Functions being controlled includes cameras, BLUETOOTH, and WI-FI. Once the terminal device can connect to a network or is taken out of the management domain, important information may be leaked, and security risks increased. Thus, the factory can provide an industrial terminal to staff in the management domain, and divide the factory into different management domains corresponding to different management requirements. How to effectively manage the industrial terminals in different domains for licensing the industrial terminals to invoke different function sets in different management domains becomes more important for both working efficiency and reduction of risk of leaks.

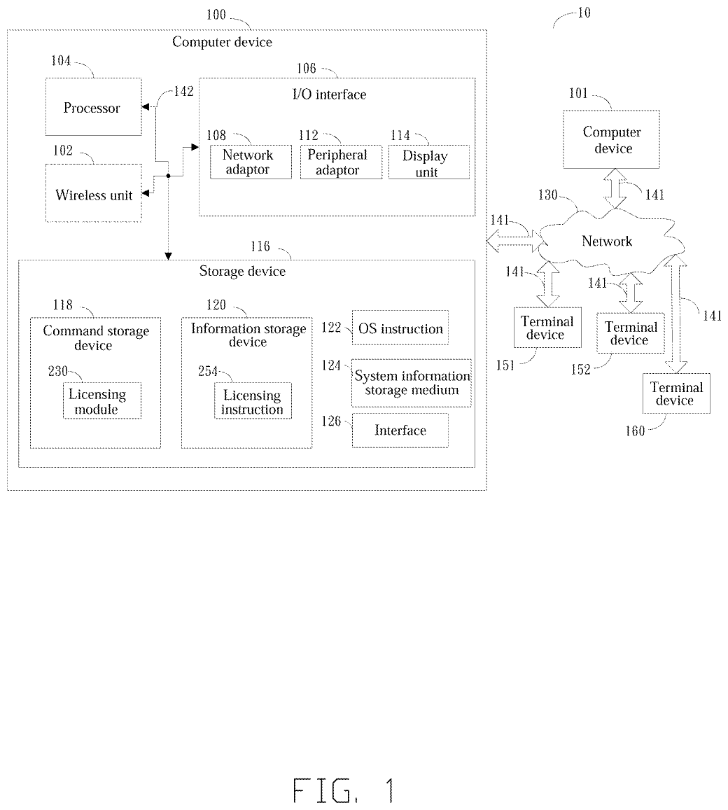

FIG. 1 illustrates one or more embodiments of an operation environment 10 of an electronic device. The environment 10 or a part of the environment 10 can form different operation environments and systems. The environment 10 includes computer devices 100, 101, terminal devices 151, 152, 160, a communication link 141, and a network 130. The computer devices 100, 101 are same or similar devices. The terminal devices 151, 152, 160 are same or similar devices. When a load number of the computer devices 100 below a maximum permitted load number, and with a low computing capacity, the environment 10 can only include a computer device 100. When there is a high computing capacity and the load number of the computer device 100 exceeds a maximum permitted load number, a same structure of the computer devices 100, 101 forms a computing system for parallel processing. A working process of the computer device 100 is explained, and a working process of the terminal device 151 is also explained. In some embodiment, the environment 10 can execute a response to one or more software modules in the computer device 100, which form a terminal device security management device.

In some embodiments, the terminal 151 forms information (such as network information) to be transmitted to the computer device 100 through the communication link 141, the network 130, and the communication link 141, thus a specified logic process is formed. The terminal device 151 can also respond to management commands (such as permission to invoke an application or to allow an application to display) of the terminal device 160. The terminal device 160 receives information from the computer device 100 (such as a verification result, an access level, and applications corresponding to the access level) to display to an administrator for monitoring the terminal device 151.

The computer device 100 includes a processor 104, one or more input and output interfaces 106, and one or more storage devices 116. A bus 142 is used for exchanging information (such as data, metadata, and/or signaling) between the processor 104, communicators (such as the input and output interface 106), the storage device 116, and/or other functional elements. The bus 142 can include system bus, memory bus, address bus, and message bus.

Through the communication path formed by the input and output interface 106, the communication link 141, the network 130, and the communication link 141, the processor 104 collects information of the terminal device 151 (such as an identity information or a network information), executes a determining action (such as determining the identity information, or determining the access level) to form a computing result (such as an identity result, the access level), and transmits the computing result to the terminal device 160. The terminal device 160 receives the computing result to form an information (such as a licensing command or an alert information) being sent to the terminal device 151.

The processor 104 also can receive the information sent from the terminal device 160 to form a computing result, and send corresponding information (such as licensing instructions) to the terminal device 151 for controlling the terminal device 151, but not being limited. When the computer device 100 includes a plurality of processors 104, the processors 104 connect with all other processors 104 to execute a parallel compute.

The storage device 116 can be different computer readable storage devices. In some embodiments, the storage device 116 can include a command storage device 118 and an information storage device 120.

The command storage device 118 can include computer accessible instruction, which can be implemented by the processor 104 to execute a terminal device management strategy of the disclosure. The computer accessible instructions can be implemented by one or more software modules in a licensing module 230. In one embodiment, the processor 104 executes the licensing module 230 to search for information in the information storage device 120, or stores the information in the information storage device 120, thus the licensing module 230 can program or allocate functions.

The information in the information storage device 120 is referred to as licensing instructions 254. The licensing instructions 254 can include at least one of code instruction and information structure. For example, a part of the information structure indicates an allowable application list of the terminal device 151 according to the access level, and a history of operation data of the terminal device 151, and so on.

The instruction storage device 118 and other executable program elements (such as OS instruction 122) are resident in different storage devices 116 of the computer device 100 at different times, and can be implemented by the processor 104. In some situation, the implementation of the licensing module 230 can be retained on the computer readable medium in a specified formation.

The storage device 116 can also include computer accessible instructions and information (such as data, metadata, and/or program code instructions), which can license or improve the operation and/or the management of the computer accessible instructions and information (such as an upgrade, software installation, or other configuration, and so on). Thus, the storage device 116 includes storage elements, which are implemented to form or include one or more operation system (OS) instructions 122, for example, a Windows operation system, Unix, Linux, Symbian, Android, Chromium, and other OS suitable for the mobile or fixed computer apparatus. The operation and/or the architectural complexity of the computer device 100 can define the suitable OS.

The storage device 116 can also include a system information storage medium 124 with data, metadata, and/or program code. The data, the metadata, and/or the program code allows the operation or management of the computer device 100. OS instructions 122 and the information storage medium 124 can be accessed or operated by the processor 104.

The storage device 116 also includes an interface 126. The interface 126 allows or promotes information communication between two or more modules in the instruction storage device 118.

In some embodiment, the I/O interface 106 allows or promotes the information communication between the computer device 100 and external devices. The communication can be a direct communication or an indirect communication. For example, the exchanging of information between the computer device 100 and the external devices can be achieved by a network or other elements. In some embodiment, the I/O interface 106 can include one of network adaptors 108, peripheral adaptors 112, display units 114, and allows or promotes the connection between the processor 104 and the storage device 116.

The network adaptors 108 allow or promote information (data, metadata, and/or instructions) exchange between the computer device 100 and one or more computer devices 101 by one or more networks 130 and one or more communication links 141 (for example, a wireless, a cable, or a combination) alone or in combination. At least one network adaptor 108 provides a network coupling in one of a wired environment or a wireless environment.

The peripheral adaptors 112 can include a group of interfaces. The interfaces include at least one of parallel interfaces, serial interfaces, ethernet interface, V.35 interfaces, X.21 interfaces. The interfaces allow or promote the wired connection between the computer device 100 and the external device. In some embodiment, the parallel interfaces can include general-purpose interface bus (GPIB) and IEEE-1284. The serial interface can include a recommended standard (RS)-232, V.11, a universal serial bus (USB), a Firewire interface, or IEEE-1394, to couple to different interfaces.

The display unit 114 can include functional elements (for example, lights, such as light emitting diodes, a display, such as liquid crystal display (LCD), a plasma display, a light emitting diode (LED) or an electrochromic display, or a combination thereof), and allows or controls the operation of the computer device 100, or transmits or discloses an operating condition of the computer device 100.

In some embodiment, the computer device 100 can include a wireless unit 102. The wireless unit 102 can include one or more antenna or communication processing unit. The wireless unit 102 allows wireless communication between the computer device 100 and another device (such as the computer device 101).

The computer device 100 also can include a power source (not shown in FIG. 1). The power source powers the components or elements. The power source can be a rechargeable power source, such as a rechargeable battery. The power source can include one or more transformers for providing suitable operation power of the components, function elements, and related circuit computer device 100. In some embodiment, the power source can be connected to a normal power grid to be charged for ensuring the operations of the devices. The power source can include an I/O interface (such as a network adaptor 108) for connecting to the normal power grid. The power source can include energy conversion components (such as solar panel) for providing external or replaceable powers or increased autonomy.

In some embodiment, the computer device 100 can be a personal computer, a notebook, a server, a router, a network computer, a peer device, or other normal network node, and so on.

In some embodiment, the terminals 151, 152, 160, can include a personal computer, a server computer, a tablet device, a mobile computer device, such as a mobile planet computer or an electric reader, a wearable computer device, and several processor systems. In other embodiments, the terminals 151, 152, 160 can include a programmable consumer electronic product, a network personal computer (PC), a minicomputer, a large scale computer, a blade computer, or a programmable logic controller.

The computer readable medium can be any available medium accessible by the computer device 100 (volatile and non-volatile medium). The computer readable medium can include a computer non-volatile storage medium (or computer readable non-volatile medium) and communication medium. In one embodiment, the computer readable non-volatile medium can include volatile medium and non-volatile medium, and a movable and/or fixed medium.

The bus 142 are connected with the other bus components through a wired or a wireless network. Each sub-system includes the processor 104, the storage device 116, and the elements in the storage device 116. The I/O interface 106 can be disposed in one or more computer devices 101, which are physically separated from each other, for forming the bus connection in this manner. A fully distributed system is formed. In some embodiment, the distributed system can implement the above functions in a configuration of a client to host or in a configuration of a client to server. The licensing module 230 and/or the licensing instructions 254 can be distributed in the computer device 100.

In some embodiment, the bus 142 represents one or more possible types of bus construction, such as a storage medium bus, a storage medium controller, a peripheral bus, an accelerated graphics port, and a processor or a local bus using bus construction. It should be noticed that, the types of bus construction can include industry standard architecture (ISA) bus, a micro channel architecture (MCA) bus, an enhanced ISA bus, a video electronics standards association (VESA) local bus, an accelerated graphics port (AGP) bus, a peripheral component interconnect (PCI) bus, a PCI-Express bus, a personal computer memory card international association (PCMCIA) bus, and a universal serial bus (USB).

In some embodiment, the method is used in the distributed computing environment (such as a grid environment). Tasks are implemented by remote computer device (the computer device 101) coupled to at least one computer device 100. In the distributed computing environment, one or more software modules (such as program module) are disposed in both the local device (such as the computer device 100) and the remote computer device.

In some embodiment, the communication link 141 can include uplink (UL) and downlink (DL). Each of UL and DL can be include a wireless link (such as a deep space wireless link and/or a land wireless link), a wired link (such as an optical line, a coaxial line, and/or a twisted-pair), or other combination.

The network 130 can include some types network components, which are a base station, a router device, a switch device, a server device, an aggregator, a bus construction, and the combinations of the recited components. The network components can be assembled to form a local area network (LAN), a metropolitan area network (MAN), a wide area network (WAN), and/or other networks with different coverage regions. At least one information transmitted by the network adapter 108 is generated by operations in the method of the embodiment. The information can be any visible representation of format, such as a text, an image, an animation, an audio, and a touch.

The environment 10 is merely illustrative, and is not intended to suggest or convey any limitations on the scope of use or function.

The software module (such as the licensing module 230) in the environment 10 can include one or more computer access instructions (such as computer readable instruction and/or computer executable instruction). Some of the computer access instructions are implemented for executing at least a part of the method of the embodiment. For achieving the above purpose, the computer access instructions are embedded into a program module to be stored in the computer readable non-volatile medium, which can be implemented by the processor (such as processor 104). For example, the processor 104 in the computer device 100 compiles, links, and/or implement the computer access instructions.

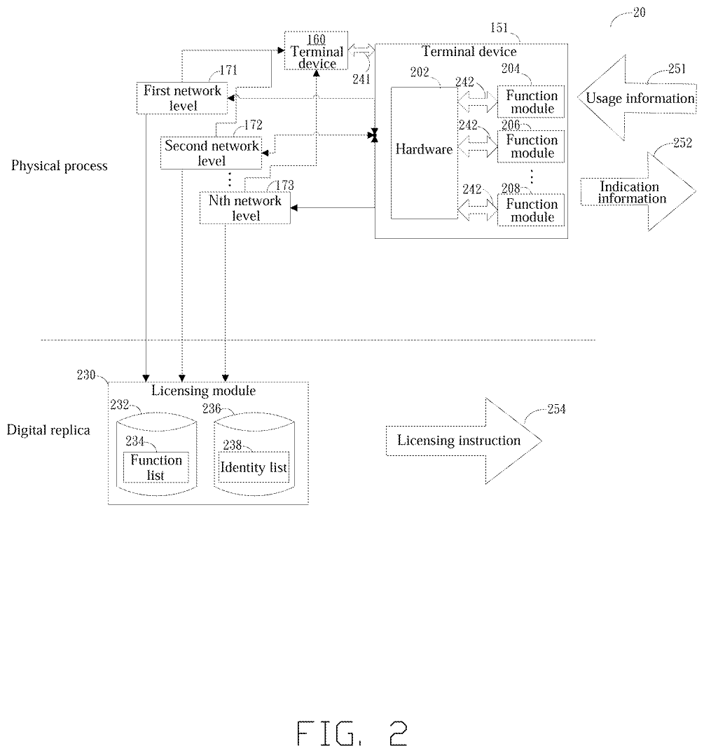

FIG. 2 shows a physical process and a digital replica of the environment 20 used in an electronic device. The environment 20 includes a physical process domain with the terminals 151, 160. The environment 20 includes a digital replica. The digital replica includes a computer implementation environment, and the process in the physical process domain can be mapped into the computer implementation environment. The digital replica uses one or a combination of modeling, computing, and artificial intelligence (AI) technologies to form the digital replica. The digital replica forms a dynamic simulation model of the physical process.

Over time, the process implemented by the terminal 151 forms an indication information 252 by a usage information 251 (such as an application program icon in a touch panel being clicked by human hand). The indication information 251 can include a necessary information representation for providing one or more functions (such as indicating the application program being forbidden under a current level of the terminal 151, or hiding the application program being forbidden under the current level of the terminal 151). The indication information 252 can be in a visible representation, such as an image data, an audio data, and/or touch data.

The terminal 151 can include a function module 204, and other function modules, such as a function module 206 and a function module 208, which respond to the usage information 251. The function module 204 for collecting indications or operation data of the terminal 151 can be embedded into the hardware 202 (not shown), or be coupled to the hardware 202 in other manner (such as using the bus 242). In some embodiments, the function module 204 are selectively implemented or displayed (such as changing the icons of the application program to be gray for indicating available, or hiding the icons of the application program) according to management instructions (such as a list of application programs corresponding to the level) from the terminal 160. Any of the function modules 204, 206, 208 can include specified management items, common management items, and configuration management items. The specified management items include an NFC management, an NFC transmission management, a camera management, a BLUETOOTH® management, and a USB management, not being limited. The common management items include a WI-FI management, a WI-FI white-listed management, a screen shot management, a watermark management, and a screen lock PIN code management, not being limited. The configuration management items include a network and internet item, a connected device item, an application and notification item, a battery item, a memory item, a display item, an audio item, a gesture item, an advanced item, a storage item, a security and location information item, an account number item, a barrier-free item, a Google item, a system item, a developer item, a search item, and an advice column display or non-display item, not being limited.

For achieving an automatic process of the terminal device 151, the terminal device 160 can functionally couple to the terminal device 151 (such as communication couple, an electrical couple, an electromagnetic couple, and/or an electromechanical couple). A communication framework 241 can allow or promote an information (such as data, metadata, and/or signaling) exchange between the terminal device 160 and the terminal device 151.

The bus 242 and the communication framework 241 can be or can include several types of network elements, which include a communication station, a router device, a switch device, a server device, an aggregator device, a bus framework, or any combination. One or more bus framework can include an industry bus framework, such as an industry ethernet bus, a controller area network (CAN) bus, a Modbus, or other types of bus frameworks.

Some computer devices are allowed or promoted to execute digital copy. The digital copy can include a computer system, which receives a data process model. The data process model can be automatically executed by the terminal device 160, and is partly implemented by the terminal device 151. The compute system can receive data, metadata, and/or code instructions (forming a library or other type of software elements). The received data, metadata, and/or code instructions are allowed to simulate a whole or a part of the data process in the physical domain.

The digital copy can include the licensing module 230. The licensing module 230 is implemented to define the available function modules of the terminal device 151 based on the terminal device 160. In some embodiments, the licensing module 230 can verify an identity information of the terminal device 151 for authorizing the terminal device 151 to connect the network. For verifying the identity information, a search is made in one or more data construction 238 (named as identity list 238) stored in one or more storage devices 236. When there is no identity information matching with the terminal device 151, a forbidden instruction is formed and sent to the terminal device 151 within the indication information 252, preventing all of the functions of the terminal device 151 to be invoked by the terminal device 151. When there is an identity information matching with the terminal device 151, a licensed instruction is outputted.

In some embodiment, when the licensing module 230 authenticates the identity information to be legal or legitimate, the network level of the terminal device 151 is obtained from the connected network of the terminal device 151, such as a first network level 171, a second network level 172, . . . , and the Nth network level 173. The network level is defined by the management domain. The network outside the management domain is defined as the third network level, the network inside the management domain is defined as the second network level 172, and the network in a strict management domain is defined as the first network level 171. The types and the number of the available function modules in the licensed terminal device 151 are different due to the different network levels. The available function modules corresponding to each network level are stored in to one or more data constructions (function list 234). The storage device 232 stores the function list 234. When the licensing module 230 obtains the connected network level of the terminal device 151, the licensing instructions 253 are formed based on the function list 234 for representing information of the function list 234, and the licensing instructions 253 are transmitted from the digital replica to the physical process domain for forming the indication information 252 identified by the objects in the interaction terminal device 151 (such as an input signal generated by users or a trigger function).

Such a digital replica can be referred to as a “digital twin” and embodies or constitutes a dynamic simulation model of the physical process. In some embodiments, the digital replica integrates at least some of the physics of the physical process, a logic that controls the physical process and a simulation model of the physical process. The digital replica can utilize or otherwise leverage data-driven approaches that utilize machine-learning based methods. In addition, or in some embodiments, the digital replica can utilize or otherwise leverage model-driven approaches based on physical phenomena underlying an industrial process and rules of such process. Accordingly, in some instances, by incorporating a model of the physical industrial process, the digital replica can be synchronized with its physical counterpart almost in real-time. The digital replica also permits or otherwise facilitates simulating and evaluating a state of the process before the state is achieved in the counterpart physical system. The digital twin can continuously learn and can update itself from multiple sources to refine its real-time representation of the physical process.

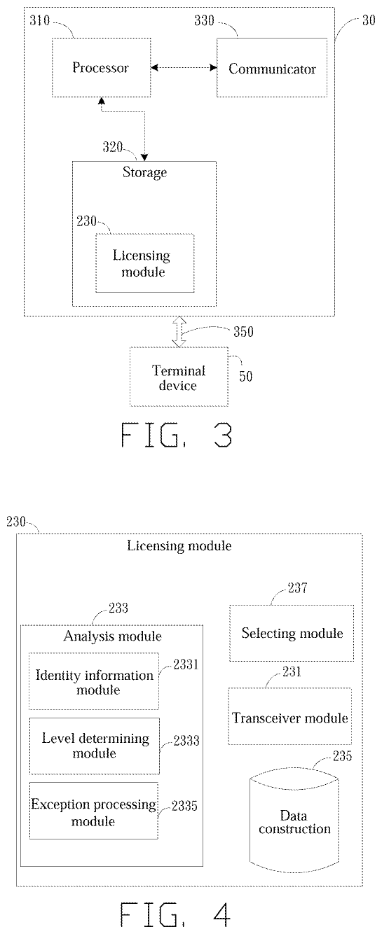

Referring to FIG. 3, in some embodiments, in some low data dimension and some small calculation scenes, such as the managed number of the terminal device 151 being less than 50, but not limited to this, a terminal security control function is implemented by a management device 30 (integrating or coupling the function of the computer device 100 into the terminal device 160). The management device 30 can include a processor 310, a storage 320, and a communicator 330. The licensing module 230 can be set in the storage 320, and the communicator 330 can serve as the UL or the DL for achieving a coupling connection or an external interaction. A communication construction 350 allows or promotes the information (data, metadata, and/or signaling) interaction between the management device 30 and the terminal device 50.

In some embodiments, the functions of elements in the management device 30 include: receiving the first network information from the terminal device 50 by the communicator 330, confirming the connected network level of the terminal device 50 to be the first network level by the processor 310 coupled to the communicator 330, forming a first licensing message with a first instruction for licensing a first function to be invoked by the terminal device 50 according to the first network level by the processor 310, transmitting the first licensing message to the terminal device 50 by the communicator 330 for licensing the first function to be invoked by the terminal device 50.

In some embodiment, the storage 320 includes the licensing module 230. The licensing module 230 is implemented to execute the function of the terminal device 50 licensed by the management device 30.

Referring to FIG. 4, in some embodiments, the licensing module 230 includes an exception processing module 237, and an analysis module 233. The licensing module 230 also can include a data construction 235, and a transceiver module 231. The data construction 235 can store data (such as the function list 234, and the identity list 238) stored in the licensing module 230. The transceiver module 231 can receive the network level confirmed by the processor 310 (such as the first network level), receive the instructions corresponding to the function module sets corresponding to the confirmed network level, and control the communicator 330 to send the licensing instructions to the terminal device 50.

In some embodiments, when the network is not switched, an action of a second function is invoked by the terminal device 50. Notification to the manager must be given, and the exception processing module 237 determines the operation of the terminal device 50 to be illegal or illegitimate based on the received exception action, and forms a warning message for prompting the manager to be aware of the exception situation. The exception processing module 237 also can send a location instruction for merely licensing a locating function and forbidding other functions of the terminal device 50 beyond the locating function, and the manager obtains the location of the terminal device 50 based on the locating function, thus a human intervention is implemented in time, and an information leakage is prevented.

In some embodiment, the analysis module 233 can include an identity information module 2331, a level determining module 2333, and a selecting module 2335.

In some embodiments, the identity information module 2331 is implemented by the processor 310 to determine whether the identity information of the terminal device 50 received by the communicator 330 matches with the specified identity information in the storage 320. When the identity information of the terminal device 50 received by the communicator 330 matches with the specified identity information in the storage 320, a verification result is outputted to the level determining module 2333. When the identity information of the terminal device 50 received by the communicator 330 does not match with the specified identity information in the storage 320, the location instruction is formed (merely the instruction of the locating function being licensed), and the location instruction is sent from the communicator 330 to the terminal device 50.

In some embodiments, when the verification result from the identity information module 2331 is received, the level determining module 2333 is implemented by the processor 310 to form the network information (such as a first network information) based on the connected network of the terminal device 50 (such as a first network, WI-FI, or cellular network), determines a configured network level of the network (the first network being configured as the first network level), and sends the determining result to the selecting module 2335.

In some embodiments, when receiving the determining result (such as the first network level), the selecting module 2335 selects the functions in the storage 320 (such as the function list 234 in the data construction 235). For example, the licensing functions stored in the data construction 235 corresponding to the first network level include a function A, a function B, and a function C; the licensing functions stored in the data construction 235 corresponding to the second network level include the function B, the function C, a function D, and a function E. When the received determining result is the second network level, the selecting module 2335 selects the licensing instructions corresponding to the functions B-E to be sent to the terminal device 50 by the communicator 330, for licensing the functions B-E to be invoked by the terminal device 50. Further, in some embodiments, the terminal device 50 includes the function A, the function B, and a function F, but there is no function E in the terminal device 50, the selecting module 2335 forms a function sign based on the function list 234 (including the function A, the function B, and the function F) of the terminal device 50 and the determining result (such as the first network level). The function signs can be the intersection functions of the function list 234 and the licensing function corresponding to the determining result, such as function signs representing the function A and the function B. The selecting module 2335 forms the first licensing message based on the function signs, such as first function sign. The first licensing message licenses the terminal device 50 to invoke functions A and B when connected to the first network level.

Further, in some embodiments, when the network of the terminal device 50 is switched (such as switching from the first network to the second network), the communicator 330 receives the second network information and sends the second network information to the processor 310. The processor 310 calls the level determining module 2333 to determine the second network to be configured at the second network level. The identity information module 2331 has outputted the verified result during the terminal device 50 connecting with the first network, there is no need to repeat the verification of the identity of the terminal device 50. The selecting module 2335 forms a second licensing message based on the second network level. For example, under the second network level, the function B, the function C, the function D, and the function E of the terminal device 50 are licensed to be invoked, but the first function (such as the function A) in the terminal device 50 is forbidden to be invoked. The selecting module 2335 forms a second licensing message excluding a first instruction for licensing the function A to be invoked by the terminal device 50. The selecting module 2335 is implemented by the processor 310 and controls the communicator 330 to send the second licensing message to the terminal device 50. When there is an external request to invoke the function A of the terminal device 50, the terminal device 50 refuses to invoke the function A based on the second licensing message. When the terminal device 50 connects with the first network, the management device 30 sends the licensing instruction for rejecting the terminal device 50 to invoke the function D. When the terminal device 50 switches to the second network, under the second network level, the function D of the terminal device 50 is licensed to be invoked. In detail, when the terminal device 50 connected with the first network receives the first licensing message, the first licensing message excludes the second instruction for licensing the function D to be invoked by the terminal device 50, thus the terminal device 50 rejects to invoke the function D. When the terminal device 50 is connected with the second network, the communicator 330 receives the second network information, the processor 310 searches the storage 320 to determine the second network to be configured as the second network level based on the second network information, and forms the second licensing message for licensing the function D to be invoked by the terminal device 50 based on the verified result and the second network level. Lastly, the processor 310 controls the communicator 330 to send the second licensing message to the terminal device 50, thus the terminal device 50 can invoke function D based on the external inputted request.

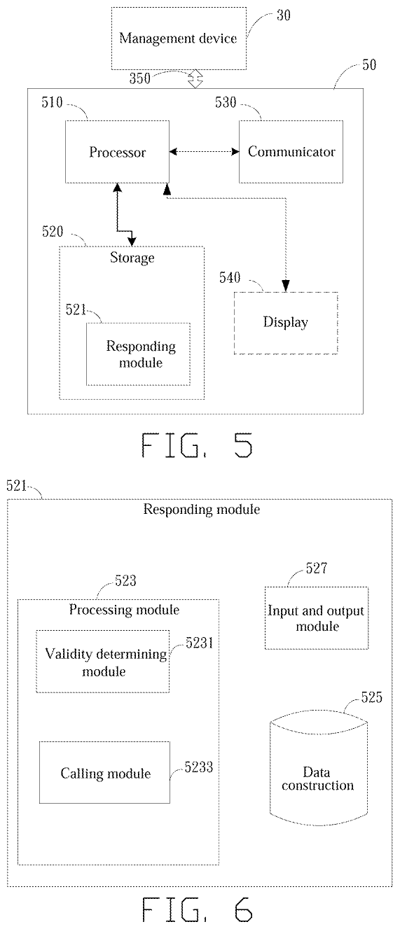

Referring to FIG. 5, in some embodiment, the terminal device 50 can include the processor 510, the storage 520 with a responding module 521, and the communicator 530. The communicator 530 serves as the UL or the DL for achieving a coupling connection or an external interaction.

In some embodiment, the functions of the elements in the management device 50 include: connecting the first network by the communicator 530, which is configured as the first network level, sending the first network information to the terminal device 50, which includes the identity information of the terminal device 50, responding to the transmission of the first network information, receiving the first licensing message from the management device 30, which licenses the first function to be invoked by the terminal device 50 based on the first network level and the identity information. The processor 510 coupled to the communicator 530 obtains a first invoking request of the first function (such as the function A), and licenses the terminal device 50 to invoke the first function based on the first invoking request and the first licensing message.

In some embodiments, the storage 520 can include the responding module 521. The responding module 521 can be implemented by one or more processor 510 while receiving the licensing instruction from the management device 30, and responses an internal or an external request for invoking the function modules of the terminal device 50. The internal is an inside of the terminal device 50, and the external is an outside of the terminal device 50. The term “internal” can be an inside of the terminal device 50 or an inside data interaction of a system with the terminal device 50 and the management device 30, such as application programs or requests of other function modules as the foregoing such as the licensing module 230, which is generated inside the system. The term “external” can be an input from the outside of the terminal device 50, such as the terminal device 50 with a touch display, a request for invoking the function module is generated when an icon in the touch display being clicked by users.

Referring to FIG. 6, in some embodiment, the responding module 521 can include a processing module 523. The responding module 521 further can include the data construction 525 and an input and output module 527. The data construction 525 stores the data in the responding module 521 (such as a first licensing message, a second licensing message, and the licensing instruction). The input and output module 527 receives the data sent by the communicator 530 from the management device 30, and outputs feedback information (such as prompting the invoking request of the function A to be illegal under current network).

In some embodiments, the processing module 523 can include a validity determining module 5231 and an implementing module 5233.

In some embodiments, the validity determining module 5231 implemented by the processor 510 determines whether the request for invoking the specified function (such as the function A) is legal under the current network environment and the network level based on the information with the licensing instruction (such as the first licensing message and the second licensing message) sent by the management device 30. When the request for invoking the specified function is legal, the determining result is sent to the implementing module 5233. When the request for invoking the specified function is illegal, a feedback is provided to the internal or the external for prompting the operation to be illegal. When the request for invoking the specified function are determined as illegal for several times, an exception record is formed, and is sent to the management device 30 by the communicator 530.

In some embodiments, the implementing module 5223 selects the corresponding function module, for example the function A, based on the internal or external request while receiving the legal result generated by the validity determining module 5231. The processor 530 is enable to invoke the function A to response the internal or the external request.

In some embodiment, if the first licensing message excludes the second instruction for licensing the second function (such as the function D) to be invoked by the terminal device 50, when the processor 510 receives the request for invoking the function D from the internal or the external, the processor 510 calls the responding module 521 to determining the request is illegal based on the request and the first licensing message, and then the request is rejected for forbidding the function D to be invoked by the external.

Further, the illegal invoking operation of the function D is prompted, and the external is noticed that the invoking of the function D is forbidden. If the function D can be invoked, the communicator 530 uploads the exception record of the invoking of the illegal function D to the management device 30, the exception processing module 237 is called for determining whether the invoking operation relates to security problems by the security manager. When the invoking operation does not relate to the security problems, the exception processing module 237 ignores the invoking operation. When the invoking operation relates to the security problems, the terminal device 50 receives a locating instruction for merely licensing a locating function, and other functions of the terminal device 50 besides the locating function are forbidden.

In some embodiments, when the connected network of the terminal device 50 changes, such as switching from the first network to the second network, the second network corresponds to the second network level, the communicator 530 receives the second licensing message from the management device 30, the second licensing message includes the second network level, the identity information, and the instruction for licensing the second function to be invoked by the terminal device 50 (such as the function D). The processor 510 calls the responding module 521, and the invoking request of the function D by the internal or the external is enabled. The second network level forbids the invoking of the first function (such as the function A), the processor 510 rejects the invoking request of the function A by the external.

In some embodiments, the terminal device 50 include the display 540. The display 540 is coupled to the processor 510. When the terminal device 50 connects with the first network, the processor 510 can invoke the first function A, and the display 540 can display a first interface for communicating with the external of the terminal device 50. The first interface includes an identifier (such as an icon) for invoking the function A by the request of the external, the identifier can be clicked by the external for generating the request for invoking the function A, thus the function A of the terminal device 50 is invoked. For example, when the terminal device 50 connects with the first network, the processor 510 rejects the invoking of the second function (such as the function D), the display 540 hides a second interface for communicating with the external of the terminal device 50. The identifier (such as an icon) for invoking the function D by the request of the external does not display in the second interface. The external cannot forwardly invoke the function D, a misuse can be prevented. By combination of the exception processing module 237, when the terminal device 50 connects with the first network, the invoking of the illegal function D is warned for preventing a leak.

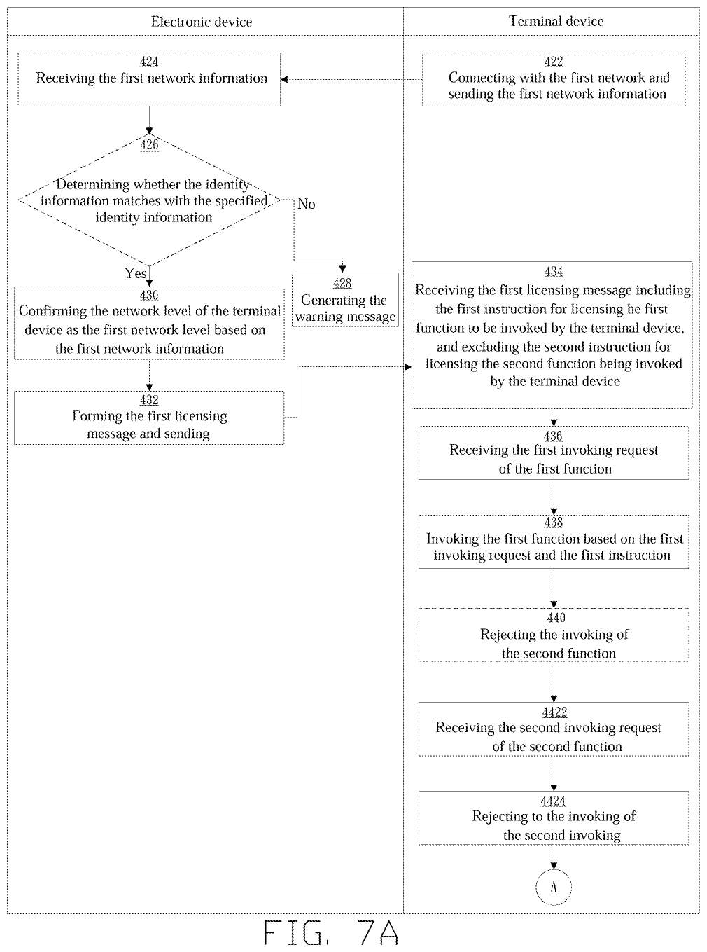

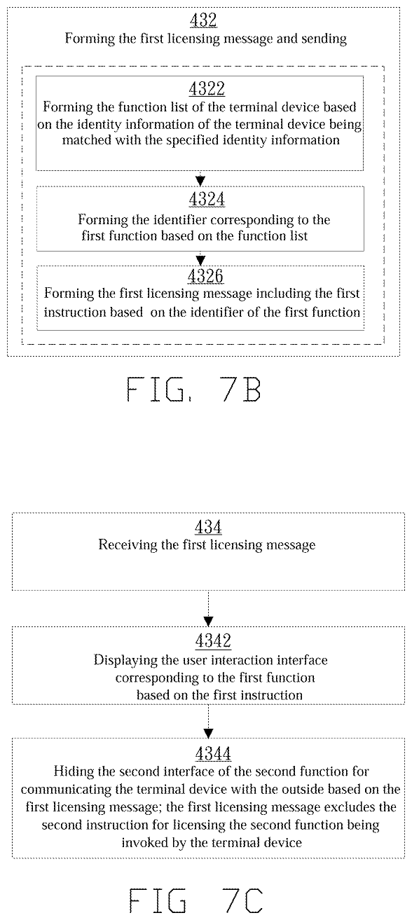

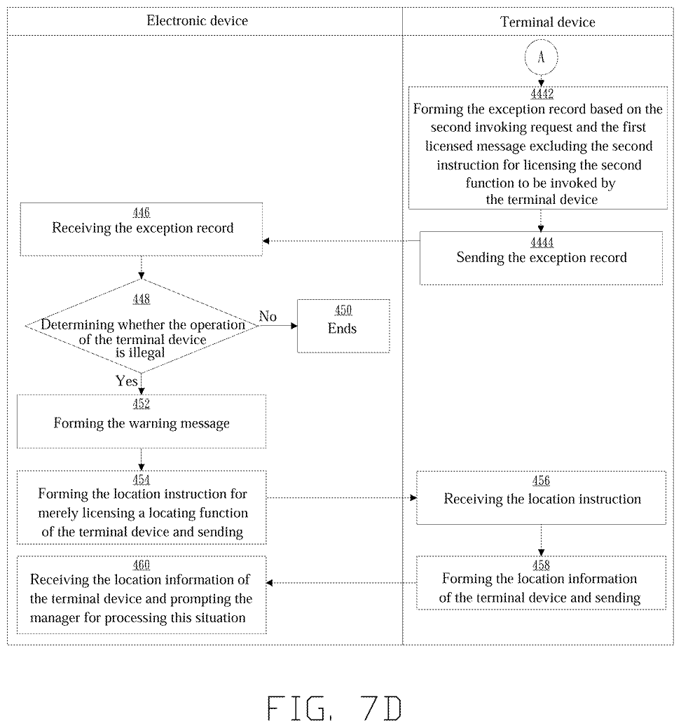

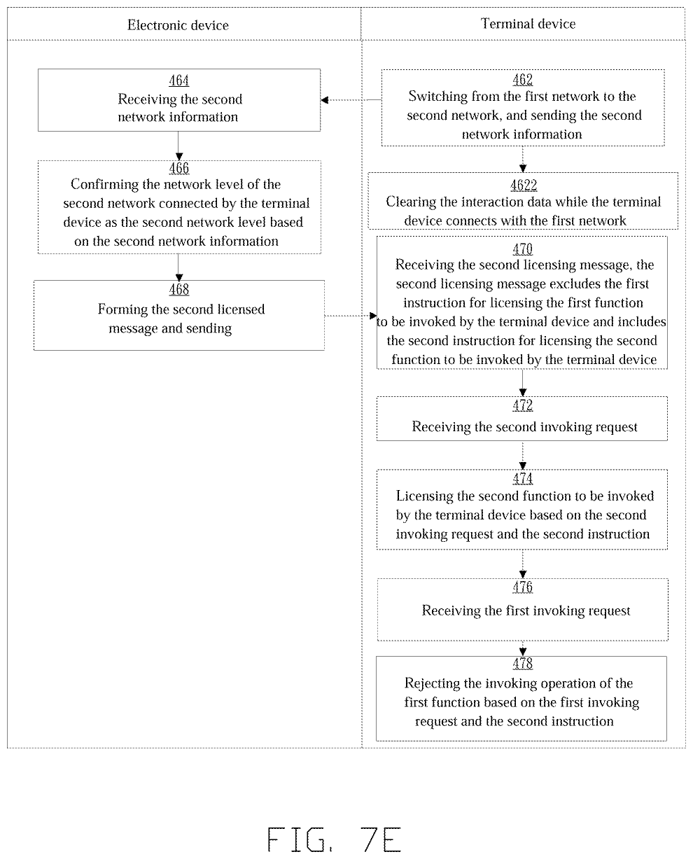

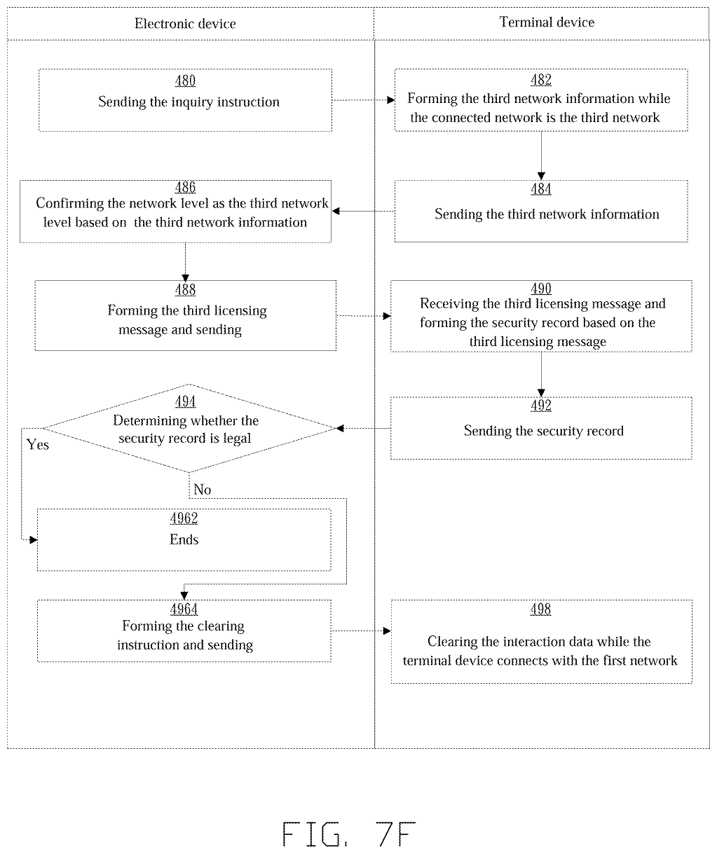

FIG. 7 shows the embodiment of a terminal device security management method.

The terminal device security management method and a terminal device using method are illustrated at the same time. The terminal security management method is used in controller device, and the terminal device using method is used in a controlled device. In the embodiment, the method is implemented by a system with the electronic device 411 (such as the computer device 100 shown in FIG. 1 or the management device 30 shown in FIG. 3) and the terminal device 412. Some operations can be selectively being combined, and the sequence of some operations can be selectively changed.

In some embodiments, the electronic device 411 pre-stores the specified identity information of the terminal device 412. The identity information can be character strings or identifiers, biological information, and near field communication (NFC) data information. The specified identity information includes the legal identity recorded in the electronic device 411, and can be added, amended, deleted, searched.

In some embodiments, in block 422, the terminal device 412 connects with the first network and sends the first network information. In block 424, the electronic device 411 receives the first network information. The first network information can include the identity information of the terminal device 412.

Selectively, in block 426, the electronic device 411 determines whether the identity information matches with the specified identity information. In block 428, a warning message is generated when the identity information does not match with the specified identity information. When the identity information matches with the specified identity information, the determining of the network level is implemented. Thus, the terminal device 412 is ensured as a legal terminal device 412 instead of a fake terminal device 412, thus a leak is prevented.

In some embodiments, after the block 426, a verification result is formed. In block 430, the electronic device 411 confirms the network level of the terminal device 412 as the first network level based on the first network information. In block 432, the first licensing message is formed and sent according to the first network level. In block 434, the terminal device 412 receives the first licensing message including a set of the functions being licensed for invoking by the internal or the external. When the request for invoking some of the functions generated by the internal or the external is in the set of the functions, the invoking of the function is licensed. When the request for invoking some of the functions generated by the internal or the external is beside the set of the functions, the invoking of the function is rejected. Thus, an abuse of the function of the terminal device 412 is prevented, and the leak is prevented.

In detail, as shown in FIG. 7B, the step of the block 432 further comprises: in the block 4322, a function list is formed based on the identity information being matched with the specified identity information. In block 4324, the identifier corresponding to the first function is formed based on the function list. In block 4326, the first licensing message with the first instruction is formed based on the identifier of the first function. In some embodiments, when the terminal device 412 includes the function A, the function B, and the function F, and the terminal device 412 excludes the function E. According to the function list of the terminal device 412 (including the function A, the function B, and the function F) and the network level (the first network level), the identifiers of the functions (an intersection between the function list and the functions licensed by the first network level, which is an intersection between the functions A-C and the functions A, the function B, and the function F as a result, identifiers corresponding to the function A and the function B) are formed. The first licensing message is formed based on the identifiers. The first licensing message licenses at least one of the function A and the function B to be invoked while the terminal device 412 connects with the first network as the first network level.

In some embodiments, as shown in FIG. 7A, in block 436, the terminal device 412 receives a first invoking request of the first function. In block 438, the first function is invoked the based on the first invoking request and the first instruction. The licensed functions of the terminal device 412 in the function set are enable.

In some embodiments, as shown in FIG. 7A, in block 440, the invoking of the second function is rejected. In block 4422, after the block 440, the terminal device 412 receives a second invoking request of the second function. In block 4424, the invoking of the second function is rejected based on the second invoking request and the first licensing message. The forbidden functions of the terminal device in the function set are disable.

As shown in FIG. 7C, in block 4342 after the block 434, an user interaction interface corresponding to the first function is displayed based on the first instruction, when the terminal device 412 is enable to invoke the first function. Thus, the first function can be invoked by clicking the user interaction interface. When there is no first instruction, the user interaction interface corresponding to the first function is hidden for preventing the first function to be invoked by the external, and the leak is further prevented. In block 4344, when the first licensing message excludes the second instruction for licensing the second function to be invoked by the terminal device 412, the second interface of the second function being communicated with the external is hidden. Thus, an error trigger is provided, and the invoking of the second function of the terminal device 412 is rejected.

As shown in FIG. 7D, in some embodiments, when the terminal device 412 triggers the block 4422 to the block 4424 by the internal or the external for several time (such as three times), as the second function is not licensed for being invoked, in block 4442, an exception record is formed based on the second invoking request and the first licensing message. In block 4444, the exception record is sent to the electronic device 411. In block 446, the electronic device 411 receives the exception record. The exception record includes the second invoking request of the terminal device 412. In block 448, whether the operation of the terminal device 412 is illegal is determined. In block 450, when the operation of the terminal device is legal, the process of the exception record ends. In block 452, when the operation of the terminal device 412 is illegal, the warning message is formed, related persons (for example, the manager of the terminal device 412, a superior manager, or other security manager) are noticed for this abnormal situation. In block 454, the locating instruction is formed and sent to the terminal device 412 for merely licensing a locating function of the terminal device 412. In block 456, the locating instruction is received by the terminal device 412. In block 458, a locating information is formed and sent to the electronic device 411. In block 460, the electronic device 411 receives the location information of the terminal device 411 and the manager is prompted for processing this situation. Thus, the exception operation can be feedbacked timely, and a loss of the leak can be prevented.

As shown in FIG. 7E, in some embodiments, in block 462, when the terminal device 412 switches from the first network to the second network, the second network information is sent to the electronic device 411. In block 464, the electronic device 411 receives the second network information. In block 466, the network level of the second network connected by the terminal device 412 is confirmed as the second network level based on the second network information. In block 468, the second licensing message is formed and sent. The second licensing message includes the second network level, the identity information, and the second instruction for licensing the second function to be invoked by the terminal device 412. The block 426 is not re-implemented, because the identity information of the terminal device 412 has been verified while the terminal device 412 connects with the first network. Thus, the efficiency and speed for managing the terminal device 412 are improved while switching the network.

In some embodiments, in block 470, a set of the functions is formed when the terminal device 412 receives the second licensing message. In block 472, a second invoking request is received. In block 474, the second function is licensed to be invoked based on the second invoking request and the second instruction. In block 476, the terminal device 412 receives the first invoking request for invoking the first function. In block 478, the invoking of the first function is rejected based on the first invoking request and the second instruction. The first function is licensed to be invoked, and the second function is rejected to be invoked when the terminal device 412 connects with the first network. After the block 470, the function list being licensed for invoking in the terminal device 412 updates.

In some embodiments, for supervising the electronic device 411, the network connected by the terminal device 412 is irregularly checked. In block 480, after the electronic device 411 forms an inquiry instruction, the inquiry instruction is sent to the terminal device 412. In block 482, a third network information is formed when the connected network is a third network. In block 484, the third network information is sent to the electronic device 411. In block 486, the network level is confirmed as the third network level based on the third network information. In block 488, a third licensing message is formed and sent to the terminal device 412 based on the third network level. In block 490, a security record is formed based on the third licensing message. In block 492, the security record is sent to the electronic device 411. The security record includes the time switching from the first network to the third network, and the data being uploaded or downloaded while connecting with the third network. The third network can include any type of network beside the first network (such as the second network). The electronic device 411 has confirmed the first network being firstly connected, thus the security record can include a switching time point and a switching duration. In block 494, whether the security record is legal is determined. In block 4962, an inquiry process ends when the security record is legal. An illegal attack is occurred while connecting with the unstable network. In block 4964, a clearing instruction is formed and sent when the security record is illegal. In block 498, the interaction data are cleared while the terminal device 412 connects with the first network. Further, the terminal device 412 can be formatted for avoiding the leak.

The foregoing terminal device security management device and method, the connected networks are classified, and a network level confirmed by the connected network is formed and sent to the terminal device for limiting the functions to be invoked, thus the function to be invoked by the terminal device is managed. The terminal devices in different management domains are managed by the connected network for licensing different function sets to be invoked by the terminal device. Thus, the efficiency of the management is improved, and the leak risk is reduced.

The terminal device and a method for limiting the invoking functions of the terminal device are also provided. By responding the information from the management device, the display displays the function sets, which is licensed to be invoked. The function is forbidden to be invoked according to the request for avoiding the specified function to be invoked in the management domain. The leak risk is further reduced.

Each module and application correspond one or more function and a set of executable instructions of the method of the disclosure. The above identified modules (i.e., sets of instructions) need not be implemented as separate software programs, procedures, or modules, and thus various subsets of these programs or modules may be combined or otherwise re-arranged in various implementations. In some embodiments, the storage medium stores a subset of the modules and data structures identified above. Besides, the storage medium stores attached modules and data structures undescribed above.

Besides, many variations and modifications can be made to the above-described embodiment(s) of the disclosure without departing substantially from the spirit and principles of the disclosure. All such modifications and variations are intended to be included herein within the scope of this disclosure and protected by the following claims. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A terminal device security management device, comprising:
a communicator, configured to receive a first network information sent by a terminal device;
a processor, coupled to the communicator, and configured to: confirm a network level of a first network connected by the terminal device as a first network level based on the first network information, form a first licensing message based on the first network level, the first licensing message comprising a first instruction for licensing a first function to be invoked by the terminal device;
wherein the communicator is further configured to send the first licensing message to the terminal device for licensing the terminal device to invoke the first function.

2. The terminal device security management device of claim 1, wherein the communicator further receives an identity information sent by the terminal device; the processor further confirms whether the identity information matches with a specified identity information; if the identity information matches with the specified identity information, forms a function list of the terminal device, and forms the first licensing message based on the first network level and the function list.

3. The terminal device security management device of claim 1, wherein the communicator further receives a second network information sent by the terminal device; the processor confirms a network level of a second network connected by the terminal device as a second network level based on the second network information; the processor further forms a second licensing message based on the second network level; the second licensing message excludes the first instruction for licensing the first function to be invoked by the terminal device; the communicator further sends the second licensing message to the terminal device for rejecting invoking of the first function.

4. The terminal device security management device of claim 1, wherein the first licensing message excludes a second instruction for licensing a second function to be invoked by the terminal device; the communicator further receives an exception record sent by the terminal device; the exception record comprises a second invoking request of the terminal device; the processor further confirms an operation of the terminal device to be illegal based on the second invoking request and the first licensing message, and forms a warning message.

5. The terminal device security management device of claim 4, wherein the processor further forms, based on the warning message, a locating instruction for merely licensing a locating function of the terminal device; the communicator further sends the locating instruction to the terminal device, and receives location information sent by the terminal device based on the locating instruction sent to the terminal device.

6. The terminal device security management device of claim 1, wherein the communicator further sends an inquiry instruction to the terminal device, and receives a third network information sent by the terminal device based on the inquiry instruction sent to the terminal device; the processor further confirms the network level of a third network connected by the terminal device as a third network level based on the third network information, forms a third licensing message based on the third network level, and the communicator further sends the third licensing message to the terminal device.

7. The terminal device security management device of claim 6, wherein the communicator further receives a security record sent from the terminal device based on the third licensing message sent to the terminal device; the processor further confirms an operation of the terminal device to be illegal based on the security record, and when the operation of the terminal device is illegal, the communicator further sends a clearing instruction for controlling the terminal device to clear interaction data generated when the terminal device connects with the first network.

8. A terminal device security management method, the method comprising:
receiving first network information sent by a terminal device;
confirming a network level of a first network connected by the terminal device as a first network level based on the first network information;
forming a first licensing message based on the first network level, the first licensing message comprising a first function for licensing a first function to be invoked by the terminal device; and
sending the first licensing message to the terminal device for licensing the terminal device to invoke the first function.

9. The terminal device security management method of claim 8, wherein the step of forming the first licensing message based on the first network level comprises:
receiving identity information sent by the terminal device;
confirming the identity information as being matched with a specified identity information;
forming a function list of the terminal device based on the identity information matched with the specified identity information; and
forming the first licensing message based on the first network level and the function list.

10. The terminal device security management method of claim 8, wherein the method further comprises:
receiving a second network information from the terminal device;
confirming the network level of a second network connected by the terminal device as a second network level based on the second network information;
forming a second licensing message based on the second network level, the second licensing message excluding a first instruction for licensing the first function to be invoked by the terminal device; and
sending the second licensing message to the terminal device for rejecting the first function to be invoked by the terminal device.

11. The terminal device security management method of claim 8, wherein the first licensing message excludes a second instruction for licensing a second function to be invoked by the terminal device; the method further comprises:
receiving an exception record from the terminal device, the exception record comprising a second invoking request of the terminal device; and
confirming an operation of the terminal device as being illegal, and forming a warning message, based on the second invoking request and the first licensing message.

12. The terminal device security management method of claim 11, wherein the method further comprises:
forming, based on the warning message, a locating instruction for merely licensing a locating function of the terminal device;
sending the locating instruction to the terminal device; and
receiving location information sent by the terminal device based on the locating instruction sent to the terminal device.

13. The terminal device security management method of claim 8, wherein the method further comprises:
sending an inquiry instruction to the terminal device;
receiving a third network information sent by the terminal device based on the inquiry instruction sent to the terminal device;
confirming the network level of a third network connected by the terminal device as a third network level based on the third network information;
forming a third licensing message based on the third network level; and
sending the third licensing message to the terminal device.

14. The terminal device security management method of claim 13, wherein the method further comprises:
receiving a security record sent from the terminal device based on the third licensing message sent to the terminal device;
confirming an operation of the terminal device to be illegal based on the security record; and
sending, when the operation of the terminal device is illegal, a clearing instruction for controlling the terminal device to clear interaction data generated when connecting with the first network.

15. A terminal device comprising:
a communicator, configured to connect with a first network, send a first network information to a management device, receive a first licensing message from the management device based on the first network information, the first licensing message comprising a first instruction for licensing a first function to be invoked by the terminal device;
a processor, coupled to the communicator, and configured to receive a first invoking request of the first function, and invoke the first function based on the first invoking request and the first instruction.

16. The terminal device of claim 15, wherein the terminal device further comprises a display coupled to the processor; the display displays a user interaction interface of the first function based on the first instruction.

17. The terminal device of claim 15, wherein the first licensing message excludes a second instruction for licensing a second function to be invoked by the terminal device; the processor further forbids the second function to be invoked based on the first licensing message excluding the second instruction for licensing the second function to be invoked by the terminal device.

18. The terminal device of claim 15, wherein the first licensing message excludes a second instruction for licensing a second function to be invoked by the terminal device; the processor receives a second invoking request of the second function, and rejects the second invoking request based on the first licensing message excluding the second instruction for licensing the second function to be invoked by the terminal device.

19. The terminal device of claim 18, wherein the processor further forms an exception record based on the second invoking request and the first licensing message excluding the second instruction for licensing the second function to be invoked by the terminal device; the communicator further sends the exception record to the management device.

20. The terminal device of claim 18, wherein the communicator further sends a second network information to the management device when switching to a second network; the communicator receives a second licensing message from the management device based on the second network information; the second licensing message comprises a second instruction for licensing a second function to be invoked by the terminal device; the processor receives a second invoking request of the second function, and invokes the second function based on the second invoking request and the second instruction.
